(19) United States
(12) Patent Application Publication
(10) Pub. No.: US 2002/0171752 A1
(43) Pub. Date: Nov. 21, 2002

(54) Apparatus and method for reducing saturation artifacts in digital images captured using frame-transfer CCD sensor with reduced-height storage area

(76) Inventor: Richard L. Baer, Los Altos, CA (US)

Correspondence Address: HEWLETT-PACKARD COMPANY, Intellectual Property Administration, P. O. Box 272400, Fort Collins, CO, 80527-2400, US

(21) Appl. No.: 09/861,075

(22) Filed: May 18, 2001

(51) Int. Cl. H04N 5/235

(52) U.S. Cl. 348/362

(57) ABSTRACT

An apparatus and method for electronically acquiring images using a frame-transfer CCD sensor with a reduced-height storage area reduces saturation artifacts in the resulting digital images by modifying the energy profile of the CCD sensor in an image area of the CCD sensor after an exposure period. The energy profile of the image area of the CCD sensor is modified by decreasing the potential applied to the substrate of the image area such that dissipation of saturated charges remaining in the image area of the CCD sensor is significantly reduced when the majority of accumulated charges is transferred from the image area to the storage area of the CCD sensor. Thus, the saturated charges in the image area and the storage area are substantially maintained at their initial levels, which results in digital images with reduced saturation artifacts.

### FIELD OF THE INVENTION

The invention relates generally to charge coupled devices, and more particularly to an apparatus and method for electronically acquiring images using a frame-transfer CCD sensor with a reduced-height storage area.

### BACKGROUND OF THE INVENTION

In contrast to a conventional film camera, a digital camera employs an electronic image sensor to digitally capture a scene of interest. Thus, the electronic image sensor functions as a film for the digital camera. Typically, the electronic image sensor is either a charge coupled device (CCD) sensor or a complementary metal oxide semiconductor (CMOS) sensor. However, due to their higher sensitivity and lower noise characteristics, CCD sensors have been much more widely adopted in applications that require high image quality.

There are a number of different types of CCD sensors, such as frame interline-transfer CCD sensors, interline-transfer CCD image sensors, and frame-transfer CCD sensors. The CCD sensors of interest herein are the frame-transfer CCD sensors. A conventional frame-transfer CCD sensor for use in digital photography includes a CCD array of pixel regions and a serial register. The CCD array includes an image area and a storage area. The pixel regions of the CCD array are defined by isolation implants and gate electrodes, which extend perpendicular to each other. The CCD array is used to accumulate electronic charges within the pixel regions in response to impinging illumination and to transfer the accumulated charges to the serial register for readout. However, the storage area of the CCD array, which has a reduced-height in comparison with the image area, is covered with an opaque mask to prevent photon-induced accumulation of charges. Thus, the storage area is exclusively used to transfer the accumulated charges in the image area to the serial register for readout. The storage area allows much of the accumulated charges in the image area to be rapidly removed from exposure to illumination without the use of a mechanical shutter, which facilitates a video mode operation for a digital camera. A video mode operation is required by a digital camera to acquire information for exposure control and focus control. In addition, a video mode operation is required to provide a user with a real time preview of the final image.

A digital camera with a conventional frame-transfer CCD sensor digitally captures a still image of a scene in the following manner. In response to a user input, the image area of the CCD array is cleared of existing charges, which begins an exposure period. During the exposure period, charges are accumulated in the pixel regions of the image area in response to impinging light. At the end of the exposure period, a mechanical shutter of the digital camera is closed to prevent further accumulation of charges. The accumulated charges in the image area are then rapidly transferred to the storage area of the CCD array. Next, the transferred charges are readout through the serial register on a row-by-row basis in a relatively slow fashion.

When light impinges upon the CCD array, photons are absorbed in the silicon, producing electron-hole pairs. The electrons are captured in potential wells, which are created in the pixel regions of the CCD array by applying predefined voltages to the gate electrodes and the substrate of the CCD array. Thus, charges are accumulated in the exposed pixel regions of the CCD array. However, when a high intensity light impinges upon a pixel region, too many photons may reach a potential well, which may cause the charges within that potential well to overflow into neighboring wells. This phenomenon is called “blooming”. A common method for controlling blooming is a “vertical anti-blooming” method. The vertical anti-blooming method establishes a potential barrier between the potential well and the substrate, which is lower than the barriers against charge flow between the neighboring wells. Thus, when too much light impinges upon a pixel region, the excess charge simply drains into the substrate, instead of flowing into the neighboring wells. The operation of the anti-blooming drain is controlled by the DC potential applied to the substrate. If the potential applied to the substrate is increased, the ability of the wells to withstand excessive illumination without blooming is also increased. However, such increase in potential reduces the charge capacity of the wells.

Unfortunately, the anti-blooming drain does not establish a rigid limit on the well capacity. Thus, if a well is overfilled with accumulated charge, the excess charge will continue to drain away over time until the well asymptotically reaches the well capacity, which can cause a problem during the image acquisition process of the digital camera. Since the storage area of the CCD array is smaller than the image area, when the accumulated charges are rapidly transferred to the storage area, some of the accumulated charges must remain in the image area until enough rows of accumulated charges have been readout through the serial register. The storage area of the CCD array typically does not have an anti-blooming drain. Thus, the saturated charges that are rapidly transferred to the storage area will not decay. However, saturated charges that remain in the image area will continue to decay. Consequently, the resulting image may have artifacts that produce a bright portion and a darker portion in the image, which are separated by a visible line. Such artifacts are referred herein as “saturation artifacts”. The bright portion of the image corresponds to the saturated charges that were rapidly transferred to the storage area, while the darker portion corresponds to the saturated charges that were left remaining in the image area.

In view of the above-described problem, there is a need for an apparatus and method for electronically acquiring images using a frame-transfer CCD sensor with a reduced-height storage area such that saturation artifacts in the resulting digital images are reduced.

### SUMMARY OF THE INVENTION

An apparatus and method for electronically acquiring images using a frame-transfer CCD sensor with a reduced-height storage area reduces saturation artifacts in the resulting digital images by modifying the energy profile of the CCD sensor in an image area of the CCD sensor after an exposure period. The energy profile of the image area of the CCD sensor is modified by decreasing the potential applied to the substrate of the image area such that dissipation of saturated charges remaining in the image area of the CCD sensor is significantly reduced when the majority of accumulated charges is transferred from the image area to the storage area of the CCD sensor. Thus, the saturated charges in the image area and the storage area are substantially maintained at their initial levels, which results in digital images with reduced saturation artifacts.

An apparatus in accordance with the invention includes an electronic image sensor with a substrate, a substrate drive circuit and an output register. The substrate drive circuit is configured to supply a first voltage to the substrate of the electronic image sensor during an exposure period when the electronic image sensor is exposed to incident light from a scene of interest to accumulate charges in the electronic sensor. The substrate drive circuit is further configured to supply a second voltage, which is a lower voltage than the first voltage, to the substrate after the exposure period. The electronic sensor of the apparatus may include a charge coupled device.

In an embodiment, the electronic image sensor includes an image area and a storage area. The storage area of the electronic sensor is smaller than the image area. In this embodiment, the substrate drive circuit may be configured to supply the first and second voltages to only the substrate in the image area of the electronic image sensor. The substrate drive circuit may also be configured to supply a third voltage, which higher than the first voltage, to the substrate of the electronic image sensor to clear the electronic image sensor of existing charges.

In an embodiment, the apparatus includes a vertical drive circuit that is configured to transfer the charges from the image area of the electronic image sensor to the storage area of the electronic sensor.

A method in accordance with the invention includes the steps of supplying a first voltage to a substrate of an electronic image sensor, exposing the electronic image sensor to incident light from a scene of interest for a predefined exposure period to accumulate charges in the electronic image sensor, supplying a second voltage, which is a lower voltage than the first voltage, to the substrate of the electronic image sensor after the predefined exposure period, and outputting the charges from the electronic image sensor. The method may further include a step of closing a mechanical shutter to block the incident light from the scene of interest, prior to the step of supplying the second voltage to the substrate.

In an embodiment, the step of supplying the second voltage to the substrate is a step of supplying the second voltage to only the substrate in an image area of the electronic image sensor. In this embodiment, the step of exposing the electronic image sensor to the incident light is a step of exposing only the image area of the electronic sensor to the incident light from the scene of interest for the predefined exposure period to accumulate the charges in the image area of the electronic image sensor. In this embodiment, the method may further include a step of transferring the charges from the image area of the electronic image sensor to a storage area of the electronic image sensor, which is smaller than the image area of the electronic image sensor.

In an embodiment, the method further includes a step of clearing the electronic image sensor of existing charges. This step of clearing the electronic image sensor may include supplying a third voltage, which is higher than the first voltage, to the substrate of the electronic image sensor.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a digital imaging apparatus in accordance with the present invention.

FIG. 2 is a block diagram of an image-acquiring unit of the digital imaging apparatus.

FIG. 3 is a partial cross-sectional view of an image area of a CCD sensor included in the image-acquiring unit.

FIG. 4 is an energy diagram of a pixel region of the image area with various energy curves for different potentials applied to the gate electrodes and the substrate.

FIG. 5 is a process flow diagram of a method of electronically acquiring images using a frame-transfer CCD sensor with a reduced-height storage area.

### DETAILED DESCRIPTION

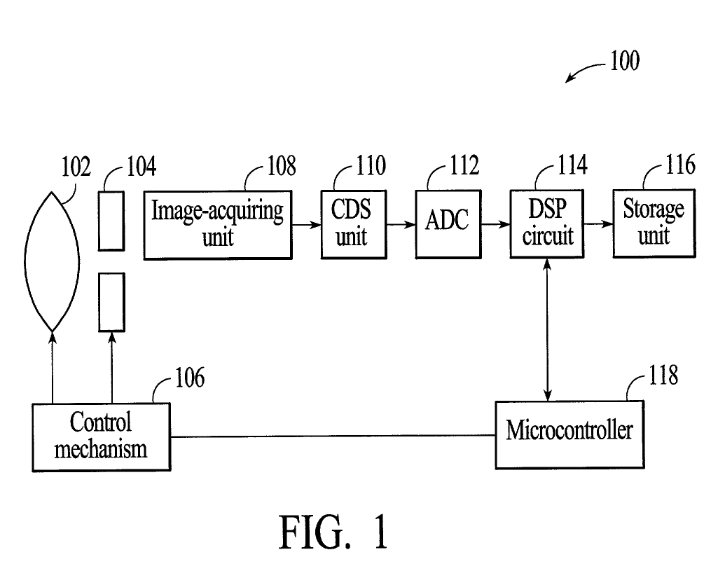

With reference to FIG. 1, a digital imaging apparatus 100 in accordance with the present invention is shown. The digital imaging apparatus utilizes a frame-transfer charge coupled device (CCD) sensor to capture a scene of interest in the form of accumulated charges in response to impinging light from the scene. The digital imaging apparatus is designed to process the accumulated charges such that saturation artifacts in the resulting digital images are substantially reduced. Consequently, the quality of bright scene images captured by the digital imaging apparatus is significantly increased.

The digital imaging apparatus 100 includes a lens 102 and a mechanical shutter 104 that are connected to a control mechanism 106, as shown in FIG. 1. The control mechanism operates to adjust the lens in order to focus a scene of interest. In addition, the control mechanism operates to open and close the mechanical shutter to control integration or exposure periods. The digital imaging apparatus further includes an image-acquiring unit 108, a correlated double sampling (CDS) unit 110, an analog-to-digital converter (ADC) 112, a digital signal processing (DSP) circuit 114, a storage unit 116, and a microcontroller 118. The image-acquiring unit operates to electronically capture a scene of interest as accumulated charges, which are sometimes referred herein as analog image signal. The image-acquiring unit then serially outputs the analog image signals for processing. The image-acquiring unit is described in more detail below.

The CDS unit 110 of the digital imaging apparatus 100 operates to reduce noises contained in the analog image signals from the image-acquiring unit 108. The noise-reduced signals are then transmitted to the ADC 112. The ADC converts the noise-reduced signals from analog image signals to digital image signals. The digital images signals are then received by the DSP circuit 114, where the digital image signals are demosaiced and compressed for storage. In addition, the DSP circuit may perform one or more image processing techniques to enhance the captured image. The processed image is then stored in the storage unit 116 of the digital imaging apparatus. As an example, the storage unit may be a flash memory. The components of the digital imaging apparatus are controlled by the microcontroller 118.

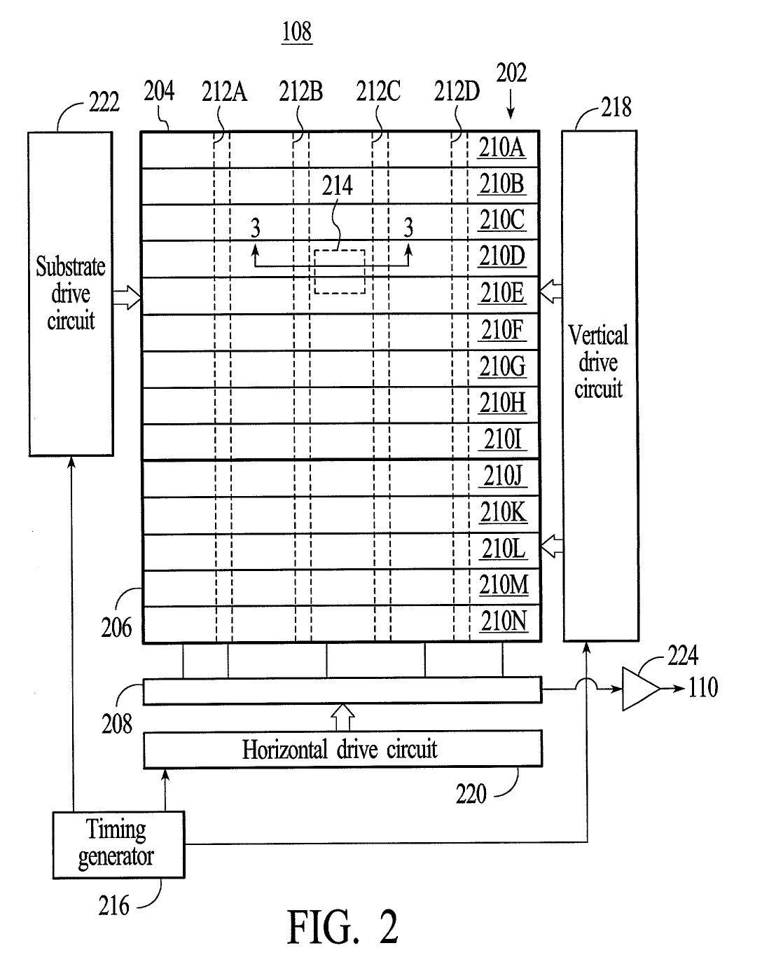

Turning to FIG. 2, a block diagram of the image-acquiring unit 108 of the digital imaging apparatus 100 is shown. As illustrated in FIG. 2, the image-acquiring unit includes a CCD sensor 202, which is configured in accordance to a frame-transfer CCD architecture. The CCD sensor includes an image area 204, a storage area 206 and a serial register 208. The image area and the storage area of the CCD sensor are structurally similar. However, the storage area is masked with an opaque shield. Thus, only the image area is exposed to illumination when the mechanical shutter 104 is opened. Furthermore, the storage area has a reduced-height as compared to the image area. The width of the storage area is the same as the image area.

The CCD image and storage areas 204 and 206 include parallel gate electrodes 210 and parallel isolation implants 212. In the exemplary embodiment, the gate electrodes are formed of poly-Si and the isolating implants are p+regions. The parallel gate electrodes extend horizontally, while the parallel isolation implants extend vertically. Although only few gate electrodes and isolation implants are shown in FIG. 2, the CCD image and storage areas includes additional gate electrodes and isolation implants. The gate electrodes and the isolation implants define pixel regions, as illustrated by a pixel region 214. In this exemplary embodiment, the pixel region 214 is a section of the CCD sensor 202 defined by the isolation implants 212B and 212C and the two gate electrodes 210D and 210E. The number of gate electrodes included in a pixel region is indicative of the charge transport phase scheme of a frame-transfer CCD sensor. In the exemplary embodiment, the CCD sensor 202 utilizes bi-phase charge transport scheme. However, the CCD sensor may utilize different charge transport scheme, such as a three-phase or four-phase charge transport scheme. In these alternative schemes, the pixel regions of the CCD sensor are defined by additional gate electrodes.

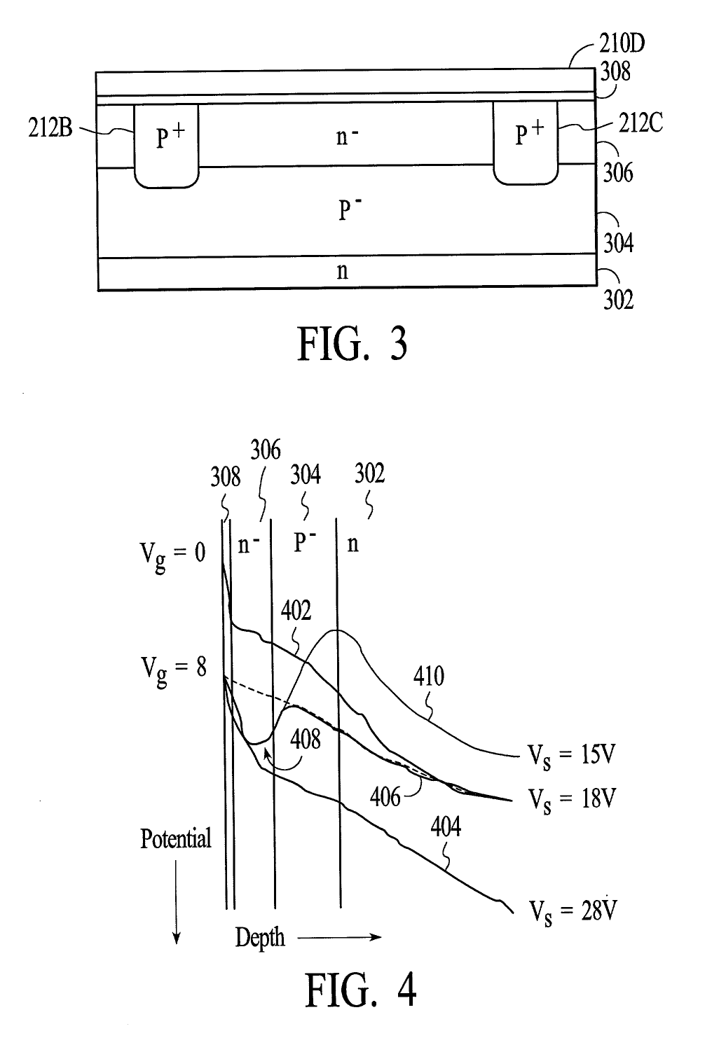

Turning now to FIG. 3, a partial cross-section of the CCD sensor 202 along the line 3-3 in FIG. 2 is shown. As illustrated in FIG. 3, the CCD sensor includes an n-type substrate 302, a p− region 304, an n− region 306, and a gate oxide 308. The gate electrode 210D and the isolation implants 212B and 212C are also shown. Depending on the voltages applied to the gate electrode 210D and the substrate, the energy profile of the CCD sensor at the pixel region 214 can be varied. As illustrated in the energy diagram of FIG. 4, the energy profile of the CCD sensor can be varied with either the voltage applied to the gate electrode or the voltage applied to the substrate.

As shown in FIG. 4, when the voltage (V_{g}) on the gate electrode 210D is 0 volts and the voltage (Vₛ) on the substrate 302 is 18 volts, the energy profile of the CCD sensor 202 is approximately defined by the energy curve 402. Similarly, when V_{g} is 8 volts and Vₛ is 28 volts, the energy profile is approximately defined by the energy curve 404. The energy curves 402 and 404 show that under these conditions, charge in the pixel region 214 will drain through the substrate. However, when V_{g} is 8 volts and the Vₛ is 18 volts, the energy profile is approximately defined by the energy curve 406, which has a potential well 408 to hold charge. The energy profile as defined by the curve 406 is used during exposure periods to accumulate charges created by impinging photons. The energy curve 406 is configured such that excess charge will drain through the substrate and not overflow to neighboring pixel regions. Thus, the energy curve 406 includes a potential barrier between the n− region 306 and the substrate 302 that is lower than the barriers between neighboring pixel regions, which provides anti-blooming control. However, this potential barrier can be raised by decreasing Vₛ, as illustrated by the energy curve 410. The energy profile as approximately defined by the curve 410 is created when V_{g} is 8 volts and Vₛ is 15 volts. As described below, the energy profiles of the CCD sensor 202 as approximately defined by the curves 406 and 410 are used to reduce saturation artifacts in the captured images.

Turning back to FIG. 2, the image-acquiring unit 108 further includes a timing generator 216, a vertical drive circuit 218, a horizontal drive circuit 220, a substrate drive circuit 222 and an amplifier 224. The timing generator provides timing signals to the vertical drive circuit, the horizontal drive circuit and the substrate drive circuit. The vertical drive circuit supplies gate voltages to the gate electrodes 210 in both the image area 204 and the storage area 206. During an exposure period, the vertical drive circuit supplies gate voltages to selected gate electrodes, creating potential wells in the pixel regions of the image area to accumulate charges. After the exposure period, the vertical drive circuit supplies gate voltages in phases to vertically transfer the accumulated charges from the image area to the serial register 208 through the storage area. Initially, the accumulated charges are rapidly transferred to the storage area. The transferred charges are then serially readout though the serial register on a row-by-row basis as analog image signals. The voltages needed by the serial register to serially readout a row of accumulated charges are supplied by the horizontal drive circuit. In the exemplary embodiment, the vertical and horizontal drive circuits supply either 0 volts or 8 volts. The analog image signals from the serial register are then amplified by the amplifier 224, before being transmitted to the CDS unit 110.

The substrate drive circuit 222 of the image-acquiring unit 108 provides substrate voltages to the substrate 302 of the image area 204 of the CCD sensor 202. The substrate drive circuit is configured to supply one of three voltages, a high voltage, a medium voltage and a low voltage. The substrate drive circuit supplies the high voltage to the substrate to clear the image area of existing charges. During exposure periods, the substrate drive circuit supplies the medium voltage to the substrate to create potential wells. During readout, the substrate drive circuit supplies the low voltage to the substrate to reduce the dissipation of saturated charges remaining in the image area after rapid transfer of the accumulated charges to the storage area. Thus, the saturated charges remaining in the image area and the saturated charges in the storage area are maintained at their initial levels, which reduces saturation artifacts. In the exemplary embodiment, the substrate drive circuit supplies 15, 18 or 28 volts.

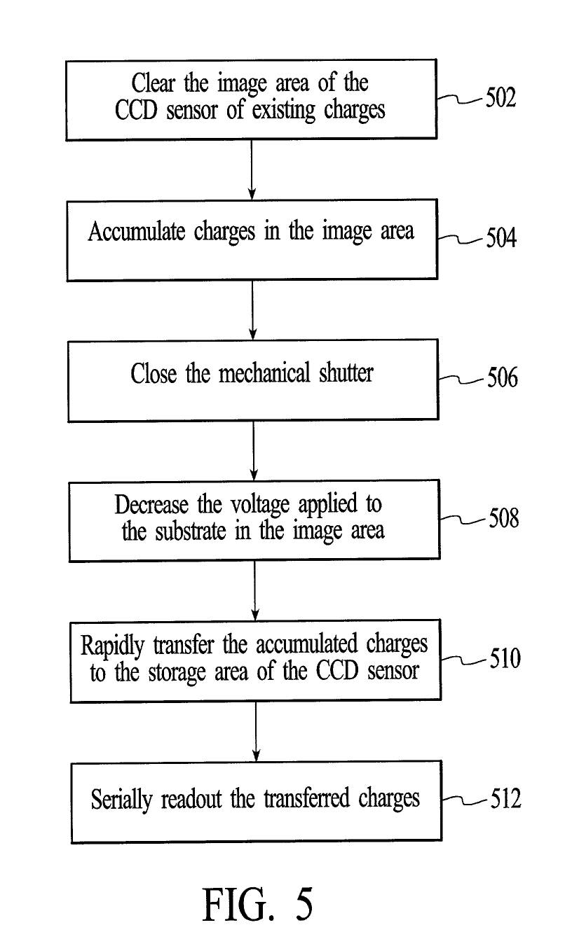

A method of electronically acquiring images using a frame-transfer CCD sensor with a reduced-height storage area is described with reference to FIGS. 5. At step 502, an image area of the frame-transfer CCD sensor is cleared of existing charges to initiate an exposure period. The image area may be cleared by setting the voltage on the gate electrodes of the image area to 0 volts. Alternatively, the image area may be cleared by pulsing the substrate of the image area with a high substrate voltage. As an example, the high substrate voltage may be 28 volts. Next, at step 504, charges are accumulated in the image area in response to impinging illumination until the end of the exposure period. During this period, the voltage applied to the activated gate electrodes of the image area is a high gate voltage, e.g., 8 volts, while the voltage applied to the substrate of the image area is a medium substrate voltage, e.g., 18 volts. At step 506, a mechanical shutter is closed to terminate the exposure period. Depending on the intensity of the impinging illumination and the duration of the exposure period, some of the accumulated charges may be saturated charges. These saturated charges will drain through the substrate due to the anti-blooming effect. Next, at step 508, the voltage on the substrate of the image area is decreased to a low substrate voltage, e.g., 15 volts, creating a higher potential barrier to the substrate to reduce the amount of saturated charges drained through the substrate.

Next, at step 510, the accumulated charges in the image area of the CCD sensor 202 are rapidly transferred to a storage area of the CCD sensor toward a serial register. However, since the storage area is smaller than the image area, some of the accumulated charges will remain in the image area. Due to the increased potential barrier to the substrate of the image area, the saturated charges remaining in the image area will not substantially drain through the substrate. At step 512, the transferred charges are serially readout through the serial register on a row-by-row basis. Since the saturated charges are substantially maintained at their initial levels during readout, saturation artifacts are reduced in the resulting image.

What is claimed is:

1. A method of electronically acquiring a scene of interest using an electronic image sensor comprising:
supplying a first voltage to a substrate of said electronic image sensor;
exposing said electronic image sensor to incident light from said scene of interest for a predefined exposure period to accumulate charges in said electronic image sensor;
supplying a second voltage to said substrate of said electronic image sensor after said predefined exposure period, said second voltage being a lower voltage than said first voltage; and
outputting said charges from said electronic image sensor.

2. The method of claim 1 wherein said step of supplying said second voltage to said substrate is a step of supplying said second voltage to only said substrate in an image area of said electronic image sensor.

3. The method of claim 2 wherein said step of exposing said electronic image sensor to said incident light is a step of exposing only said image area of said electronic image sensor to said incident light from said scene of interest for said predefined exposure period to accumulate said charges in said image area of said electronic image sensor.

4. The method of claim 3 further comprising a step of transferring said charges from said image area of said electronic image sensor to a storage area of said electronic image sensor, said storage area being smaller than said image area.

5. The method of claim 4 wherein said step of outputting said charges from said electronic image sensor includes serially outputting a row of said charges in said storage area of said electronic image sensor for processing.

6. The method of claim 1 further comprising a step of clearing said electronic image sensor of existing charges.

7. The method of claim 6 wherein said step of clearing said electronic image sensor includes supplying a third voltage to said substrate of said electronic image sensor, said third voltage being higher than said first voltage.

8. The method of claim 1 further comprising a step of closing a mechanical shutter to block said incident light from said scene of interest, prior to said step of supplying said second voltage to said substrate of said electronic image sensor.

9. The method of claim 1 wherein said electronic image sensor includes a charge coupled device.

10. An apparatus for digitally capturing a scene of interest comprising:
an electronic image sensor having a substrate;
a substrate drive circuit operatively coupled to said electronic image sensor to supply a first voltage and a second voltage to said substrate of said electronic image sensor, said substrate drive circuit being configured to supply said first voltage to said substrate of said electronic image sensor during an exposure period when said electronic image sensor is exposed to incident light from said scene of interest to accumulate charges in said electronic image sensor, said substrate drive circuit further being configured to supply said second voltage to said substrate of said electronic image sensor after said exposure period, said second voltage being a lower voltage than said first voltage; and
an output register coupled to said electronic image sensor to output said charges from said electronic image sensor.

11. The apparatus of claim 10 wherein said electronic image sensor includes an image area and a storage area, said storage area being smaller than said image area.

12. The apparatus of claim 11 wherein said substrate drive circuit is configured to supply said first and second voltages to only said substrate in said image area of said electronic image sensor.

13. The apparatus of claim 11 further comprising a vertical drive circuit coupled to said electronic image sensor, said vertical drive circuit being configured to transfer said charges from said image area of said electronic image sensor to said storage area of said electronic image sensor.

14. The apparatus of claim 11 wherein said electronic image sensor includes a charge coupled device.

15. The apparatus of claim 10 wherein said substrate drive circuit is configured to supply a third voltage to said substrate of said electronic image sensor, said third voltage being higher than said first voltage, said third voltage being supplied to said substrate of said electronic image sensor to clear said electronic image sensor of existing charges.

16. A method of capturing a scene of interest using a charge coupled device (CCD) image sensor comprising:
supplying a first voltage to a substrate of said CCD image sensor, said first voltage to said substrate at least partly defining an energy profile of said CCD image sensor;
exposing said CCD image sensor to incident light from said scene of interest for a predefined exposure period to accumulate charges in said CCD image sensor; and
supplying a second voltage to said substrate of said CCD image sensor after said predefined exposure period, said second voltage being a lower voltage than said first voltage to modify said energy profile of said CCD image sensor such that a greater potential barrier to said substrate is created; and
outputting said charges from said CCD image sensor.

17. The method of claim 16 wherein said step of supplying said second voltage to said substrate is a step of supplying said second voltage to only said substrate in an image area of said CCD image sensor.

18. The method of claim 17 wherein said step of exposing said CCD image sensor to said incident light is a step of exposing only said image area of said CCD image sensor to said incident light from said scene of interest for said predefine exposure period to accumulate said charges in said CCD image sensor.

19. The method of claim 16 further comprising a step of clearing said CCD image sensor of existing charges.

20. The method of claim 19 wherein said step of clearing said CCD image sensor includes supplying a third voltage to said substrate of said CCD image sensor, said third voltage being higher than said first voltage.

21. The method of claim 16 further comprising a step of closing a mechanical shutter to block said incident light from said scene of interest, prior to said step of supplying said second voltage to said substrate of said CCD image sensor.
